(19) United States
(12) Patent Application Publication
(10) Pub. No.: US 2007/0055685 A1
(43) Pub. Date: Mar. 8, 2007

(54) Telecommunications terminal with multiple display modes

(75) Inventors: Sandra R. Abramson, Freehold, NJ (US); Rituraj Sinha, West Orange, NJ (US); Eric Nguyen-Van-Duong, Jersey City, NJ (US); Vincent A. Illuzzi, Toms River, NJ (US); John W. Soltes, Ocean Township, NJ (US)

Correspondence Address: DEMONT & BREYER, LLC, 100 COMMONS WAY, STE 250, HOLMDEL, NJ, 07733, US

(73) Assignee: Avaya Technology Corp., Basking Ridge, NJ (US)

(21) Appl. No.: 11/207,158

(22) Filed: Aug. 18, 2005

(51) Int. Cl. G06F 7/00

(52) U.S. Cl. 707/102

(57) ABSTRACT

An apparatus and a method are disclosed for handling multiple display modes, such as column-first and row-first display modes. In particular, a telecommunications terminal receives a computer file (e.g., an HTML-encoded file, etc.) from a content server. The computer file comprises a data-ordering tag, in accordance with the illustrative embodiment of the present invention, along with one or more displayable data items. Based on the data-ordering tag, the terminal with its browser first maps the data items into an N-row by M-column array of display cells in accordance with the illustrative embodiment, wherein N and M are positive integers. The terminal then displays the mapped data items in the array of display cells. The telecommunications terminal further comprises a two-dimensional array of buttons. Each cell in the array of display cells is associated with one or more buttons in the array of buttons.

### FIELD OF THE INVENTION

The present invention relates to telecommunications in general, and, more particularly, to a telecommunications terminal that is capable of multiple display modes.

### BACKGROUND OF THE INVENTION

The Internet is an important network for presenting and distributing information. Data content, which represents the information, is available through the Internet in computer files. A telecommunications terminal that connects to the Internet, such as a personal computer, can retrieve, read, and display portions of content known as “data items” that are contained in the computer files. The data items represented in the computer files include text, images, animation, audio, and video, and can be associated with links to other content, including “web pages.” The programming language used to represent the data content in the computer files is typically Hypertext Markup Language, or HTML. An HTML-encoded computer file comprises (i) text (or other data items) displayed by the telecommunications terminal and (ii) tags, which specify to the terminal how to display the text, among other things.

In order to read the data content, the telecommunications terminal must have a browser, which is able to reproduce, on the display of the terminal, the data content received from the Internet. Generally, the view that the browser produces on the display of the terminal is such that the actual information that is part of the received data content appears in a content area located in the center of the display. In addition, the browser might display a header bar on the upper part of the display and a task bar below it with a separate menu part and an icon part. Below the task bar might be an address line and on the edge of the display, a vertical scroll bar. By selecting the menus, icons, and selectable information on the display itself, the terminal's user is able to control what the browser subsequently presents.

Traditional web browsers have been developed primarily for personal computers that have a pointing and selecting device, such as a mouse. In contrast, browsers for other types of telecommunications terminals, such as browser-capable telephones, often do not have a pointing device. Instead, those types of terminals might have display buttons that are adjacent to different areas on the display; the data items that make up the data content are displayed in those areas. When the user wants to select the data item that appears in a particular area on the display, he or she presses the display button that is adjacent to (or associated with) that item, thereby controlling the operation of the browser.

The problem with some browser-capable terminals—in particular, those with button-controlled browsers—is that, on a given display, some data content displays better than other data content. For example, a tall and narrow display might not satisfactorily portray data content that appears best on a short and wide display. Consider that the data content might comprise data items that are logically related. A laptop display might preserve the relationships when displaying the data items, but a telephone deskset display might distort the relationships, even though the individual data items might still appear somewhere on the display. Furthermore, presenting the data content satisfactorily often requires that an application developer customize the data content for each type of displaying terminal, which sometimes requires significant effort.

### SUMMARY OF THE INVENTION

The present invention is a telecommunications terminal that can handle multiple display modes, such as column-first and row-first modes, without some of the disadvantages in the prior art. In particular, the terminal receives a computer file (e.g., an HTML-encoded file, etc.) from a content server. The computer file comprises a data-ordering tag, in accordance with the illustrative embodiment of the present invention, along with one or more displayable data items. Based on the data-ordering tag, the terminal along with its browser first maps the data items into an N-row by M-column array of display cells in accordance with the illustrative embodiment, wherein N and M are positive integers. The terminal then displays the mapped data items in the array of display cells. For example, a set of data items will display in column-first order if the data-ordering tag has a first value; the same set of data items will display in row-first order if the data-ordering tag has a second value.

Having multiple display modes that are specifiable by using the data-ordering tag gives an application developer the ability to (i) account for the relationships between data items in the data content and (ii) preserve those relationships visually, without having to modify the data content significantly. For example, the developer, working with data items in a paired relationship, can prepare data content intended for a two-column terminal by indicating “row-first” ordering in the data-ordering tag to preserve the paired relationship on the display.

In addition, the data-ordering tag gives the application developer the flexibility to reuse the same set of data items for different types of telecommunications terminals, without having to re-code significantly the computer files that comprise the data items. The developer, for example, can copy the same set and sequence of data items into multiple computer files and specify a different data-ordering tag in each file. When a column-oriented terminal requests the set of data items from the content server, the server can provide that terminal with the computer file that specifies “column-first” display order. When a row-oriented terminal requests the set of data items from the content server, the server can provide that terminal with the computer file that specifies “row-first” display order.

The telecommunications terminal of the illustrative embodiment further comprises a two-dimensional array of buttons, in addition to a display. Each cell in the array of display cells is associated with one or more buttons in the array of buttons. The terminal receives one or more links in the computer file, in some embodiments, and maps the links into the array of buttons, based on the data-ordering tag. If the terminal's user actuates one of the buttons, the terminal selects the link that is associated with the actuated button. Selecting the link causes a predetermined event to occur, such as retrieving, mapping, and displaying another set of data items; initiating a telecommunications session; and so forth.

The illustrative embodiment of the present invention comprises: a network interface for receiving a computer file that comprises a data-ordering tag, a first data item, a second data item, and a third data item; a display that is capable of displaying the first data item, the second data item, and the third data item in an N-row by M-column array of cells, wherein N and M are integers, and wherein N≧2, and wherein M≧2; and a processor for mapping the first data item, the second data item, and the third data item into the array of cells in column-first order unless: (i) the processor recognizes the data-ordering tag as a valid tag and (ii) the data-ordering tag indicates that the first data item, the second data item, and the third data item should be mapped into the array of cells in row-first order.

### BRIEF DESCRIPTION OF THE DRAWINGS

FIG. 1 depicts telecommunications system 100, in accordance with the illustrative embodiment of the present invention.

FIG. 2 depicts a block diagram of the salient components of telecommunications terminal 101, in accordance with the illustrative embodiment of the present invention.

FIG. 3 depicts a portion of the front view of telecommunications terminal 101.

FIGS. 4A through 4C depict the display modes supported by the browser of terminal 101, in accordance with the illustrative embodiment of the present invention.

FIG. 5 depicts a flowchart of the operation of telecommunications terminal 101 in receiving and displaying data content, in accordance with the illustrative embodiment of the present invention.

### DETAILED DESCRIPTION

The term appearing below is given the following definition for use in this Description and the appended Claims.

For the purposes of this specification and claims, the term “link” is defined as an element in a computer file that points to a document, to a specific location in a document, or to an executable object, such as a dialer of a specified telephone number. The computer file might be encoded, for example, in the Hypertext Markup Language (HTML). Selecting the link—by actuating a corresponding button, for example—causes the underlying browser application to initiate a task, such as displaying the document or dialing an associated telephone number.

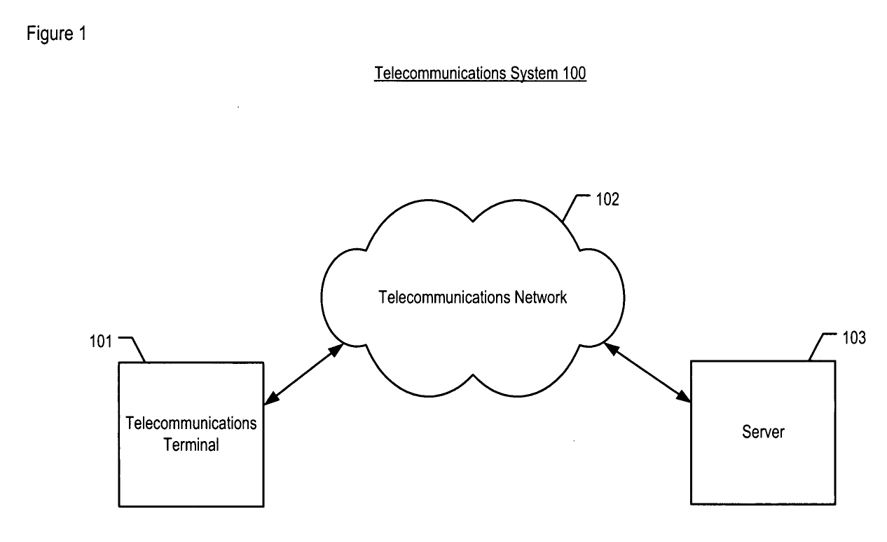

FIG. 1 depicts telecommunications system 100, in accordance with the illustrative embodiment of the present invention. Telecommunications system 100 comprises telecommunications terminal 101, telecommunications network 102, and server 103, interconnected as shown.

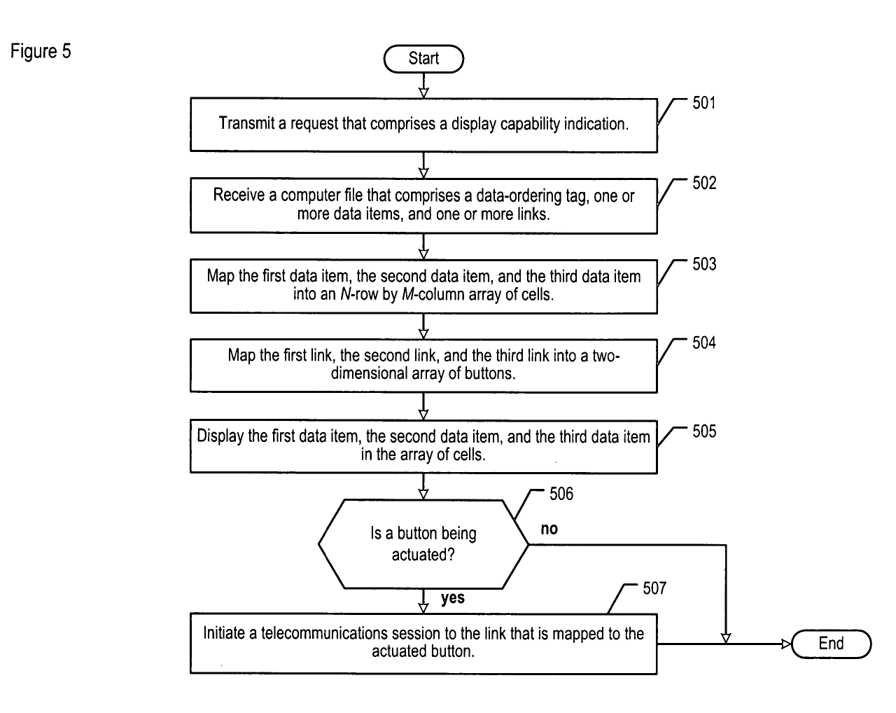

Telecommunications terminal 101 is a client machine that is capable of transmitting and receiving packets of data via telecommunications network 102, in well-known fashion. For example, a user of terminal 101 might request information, whereupon terminal 101 transmits the request to a content server, such as server 103, and subsequently receives the requested information. Terminal 101 is also capable of performing the tasks described below and with respect to FIG. 5, in accordance with the illustrative embodiment of the present invention.

Terminal 101, in the illustrative embodiment, is an Internet Protocol (IP) telephone. In some alternative embodiments, terminal 101 might be another type of telecommunications terminal (e.g., Personal Digital Assistant [PDA], softphone, Session Initiation Protocol [SIP] endpoint, H.323 endpoint, personal computer, etc.). In any case, it will be clear to those skilled in the art, after reading this specification, how to make and use telecommunications terminal 101.

Telecommunications network 102 provides for end-to-end data communications between clients, such as terminal 101, and servers, such as server 103. Network 102 comprises the Internet, in accordance with the illustrative embodiment of the present invention. In some alternative embodiments, network 102 comprises a different network or networks (e.g., an Ethernet-based network, etc.), in addition to or as an alternative to the Internet. It will be clear to those skilled in the art how to make and use network 102.

Server 103 is a source of stored data content, such as web pages and other information that is presentable to a user. Moreover, server 103 is capable of transmitting and receiving packets of data that are related to the stored content, via telecommunications network 102 in well-known fashion. Server 103 transmits the content in the form of one or more computer files to a client, such as terminal 101, either (i) when the client requests the content or (ii) autonomously. It will be clear to those skilled in the art, after reading this specification, how to format the computer files that contain the content. It will also be clear to those skilled in the art how to make and use server 103.

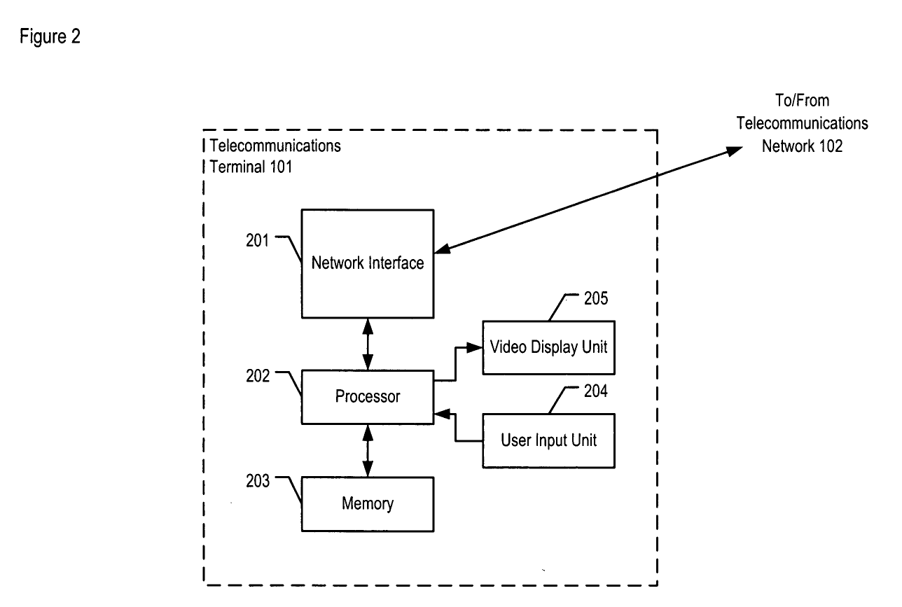

FIG. 2 depicts a block diagram of the salient components of telecommunications terminal 101, in accordance with the illustrative embodiment of the present invention. Telecommunications terminal 101 comprises: network interface 201, processor 202, memory 203, user input unit 204, and video display unit 205, interconnected as shown.

Network interface 201 comprises a receiving part and a transmitting part. The receiving part receives signals from network 102, and forwards the information encoded in the signals to processor 202, in well-known fashion. The transmitting part receives information from processor 202, and outputs signals that encode this information to network 102, in well-known fashion. It will be clear to those skilled in the art, after reading this disclosure, how to make and use network interface 201.

Processor 202 is a general-purpose processor that is capable of (i) receiving information from network interface 201 and user input unit 204, (ii) reading data from and writing data into memory 203, (iii) executing the tasks described below and with respect to FIG. 5, and (iv) transmitting information to network interface 201 and video display unit 205. In some alternative embodiments of the present invention, processor 202 might be a special-purpose processor. In either case, it will be clear to those skilled in the art, after reading this disclosure, how to make and use processor 202.

Memory 203 is a non-volatile random-access memory that stores the instructions and data used by processor 202. In accordance with the illustrative embodiment, memory 203 also stores the browser application and the retrieved computer files that contain data content. It will be clear to those skilled in the art how to make and use memory 203.

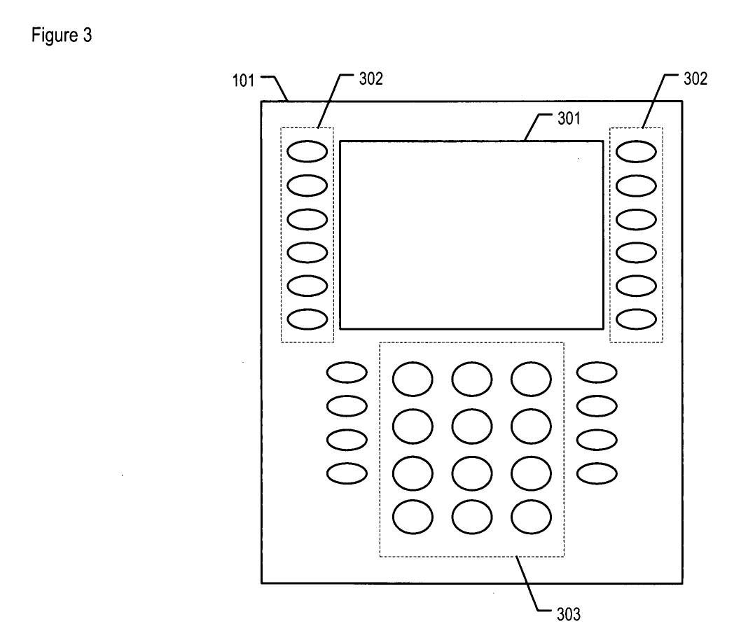

User input unit 204 is a character and user-selection input device that receives input from a user and transmits signals that represents the input to processor 202. User input unit 204 comprises fixed function keys and soft keys, as are known in the art, and provides a user input interface. User input unit 204 comprises array of buttons 302, which is described below and with respect to FIG. 3. It will be clear to those skilled in the art, after reading this disclosure, how to make and use unit 204.

Video display unit 205 is a display output system as is well known in the art that receives a video signal and creates a visual image of the signal for a user. Video display unit 205 comprises display 301, which is further described below and with respect to FIG. 3. It will be clear to those skilled in the art, after reading this disclosure, how to make and use video display unit 205.

FIG. 3 depicts a portion of the front view of telecommunications terminal 101, in accordance with the illustrative embodiment of the present invention. Depicted as part of terminal 101 are display 301, array of buttons 302, and dialing keypad 303. As those who are skilled in the art will appreciate, other physical configurations of terminal 101 may exist that incorporate the functionality described below and with respect to FIG. 5.

Display 301 is capable of displaying one or more data items in an N-row by M-column array of display cells, in accordance with the illustrative embodiment of the present invention, wherein N and M are positive integers. The values for N and M can vary from one display session to another, depending in part on the contents of each computer file retrieved from content servers.

Array 302 comprises buttons, wherein each button is associated with a different display cell on display 301. The purpose of each button is to enable the selecting of a link that is associated with a data item displayed on display 302 adjacent to the button. For example, suppose that display 301 displays a hotel services menu, in which the first item on the menu (i.e., the first data item) is displayed next to a particular button. The actuating of the button in the example results in the selecting of the first menu item, such as room service, as well as the associated link, such as a pointer to an application that dials the room service number. Although there are twelve display-associated buttons depicted in FIG. 3, it will be clear to those skilled in the art how to make and use array 302 with a different number of buttons.

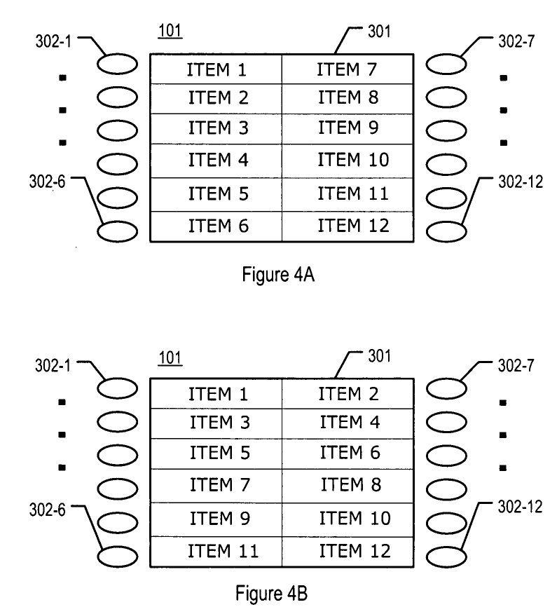

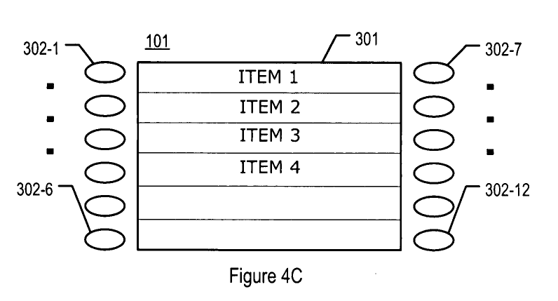

Display 301 and array 302 are further described with respect to FIGS. 4A through 4C.

Dialing keypad 303 is also part of user input unit 204 and is used by terminal 101's user to dial a telephone number. For example, the user might see a telephone number displayed on display 301 and might choose to dial the number manually by using dialing keypad 303. It will be clear to those skilled in the art how to make and use dialing keypad 303.

FIGS. 4A through 4C depict the display modes supported by the browser of terminal 101, in accordance with the illustrative embodiment of the present invention. The display mode in the illustrative embodiment is specified by a data-ordering tag, which is in the computer file that comprises displayable data items. The data items are either (i) the literal, displayable information (e.g., text, etc.) or (ii) pointers to the information that is to be displayed. As those who are skilled in the art will appreciate, terminal 101 uses a default display mode (e.g., column-first display order, etc.) if it cannot recognize the data-ordering tag as a valid tag. It will be further appreciated that terminal 101, in some alternative embodiments, might support other or additional display modes than those depicted.

FIG. 4A depicts a multi-column, column-first display mode. That is, the text “ITEM 1” is displayed in the display cell in the upper left corner (i.e., row 1, column 1). The text “ITEM 2” is displayed in the next display cell in the same column (i.e., row 2, column 1). The other data items fill the display cells in column 1 first and then in column 2.

FIG. 4B depicts a multi-column, row-first display mode. That is, the text “ITEM 1” is displayed in the display cell in the upper left corner (i.e., row 1, column 1). The text “ITEM 2” is displayed in the next display cell in the same row (i.e., row 1, column 2). The data items fill the display cells in row 1 first, then in row 2, and so on.

FIG. 4C depicts a single-column display mode. That is, the text “ITEM 1” is displayed in the display cell that now occupies the full width of the first line. The text “ITEM 2” is displayed in the display cell that now occupies the full width of the second line. The data items fill the display cells consecutively. Note that in FIG. 4C, there are two buttons adjacent to each display cell, instead of there being a one-to-one relationship. That is, there are display modes in which each cell in the array of display cells can be associated with one or more buttons in array 302. Furthermore, note that there are fewer data items that need to be displayed (i.e., four data items) than there are display cells available for the particular display mode (i.e., six display cells), which reflects the notion that the number of data items is not necessarily fixed and the displayed items do not necessarily fill the display area.

In some alternative embodiments, some or all of the display modes might comprise special navigation icons that the browser displays along a side of display 301. For example, referring to FIG. 4C, the navigation icons could be displayed on the right and would be associated with buttons 302-7 through 302-12 (i.e., the buttons to the right of display 301); the data items displayed would be associated only with buttons 302-1 through 302-6 (i.e., the buttons to the left of display 301).

The multiple display modes depicted in FIGS. 4A through 4C provide an application developer, who creates the computer files that contain the data content, the choice of selecting the best display mode with which to portray the particular content on the particular terminal used (e.g., terminal 101, etc.). The application developer accomplishes this by selecting the appropriate value for the data-ordering tag (i.e., column-first, row-first, single-column, and so forth).

In a first example, the developer develops a set of data items that he intends to be displayed on a variety of telecommunications terminals. He copies the same set of data items into multiple computer files with each computer file comprising a different data-ordering tag. Some terminals—terminal 101, for example—have more rows than columns (i.e., N>M) and, when requesting data content, might be provided with a computer file that specifies “column-first” ordering in its data-ordering tag. Other terminals might have more columns than rows (i.e., N<M) and, as a result, might be provided a computer file that specifies “row-first” ordering in its data-ordering tag. In this first example, the developer has been able to account for a variety of different terminals in the programming of data content, without having to modify the data content significantly to account for each terminal.

In a second example, the developer develops a set of data items that he intends to be displayed on a specific type of telecommunications terminal, such as terminal 101, with several rows and two columns. He adds data items that are related in pairs to the computer file, such as “Room Service” and “Cleaning Service”, “Restaurant” and “Bar”, “Hotel Pool” and “Fitness Center”, and “Front Desk” and “Hotel Operator”. For the data-ordering tag, the developer specifies a display mode of “row-first” because doing so will maintain the paired relationship of the data items on the two-column display. In this second example, the developer has been able to account for the relationships between data items in the data content and to preserve those relationships visually, without having to modify the data content significantly.

Continuing with the second example, a portion of the content of the computer file might comprise the following HTML code:

<html>
<mode 2>
<cell 1>
Room Service
</cell 1>
<cell 2>
Cleaning Service
</cell 2>
...
</html>

In the example, the tag “<mode 2>” specifies that the application programmer intends for the data items to be displayed in a “multi-column, row-first” mode. The “<cell 1>” tag specifies that the displayable data item that follows in the next line (i.e., “Room Service”) is to be stored and displayed as part of “cell 1,” in accordance with the illustrative embodiment. The “<cell 2>” tag specifies that the displayable data item that follows in the next line (i.e., “Cleaning Service”) is to be stored and displayed as part of “cell 2.” As those who are skilled in the art will appreciate, other choices of syntax are possible (e.g., “row-first” instead of “mode 2”, etc.) within the scope of the invention.

FIG. 5 depicts a flowchart of the operation of telecommunications terminal 101 in receiving and displaying data content, in accordance with the illustrative embodiment of the present invention. It will be clear to those skilled in the art which tasks depicted in FIG. 5 can be performed simultaneously or in a different order than that depicted.

At task 501, telecommunications terminal 101 transmits a request for data content to server 103. The request comprises an indication of the display capability of terminal 101. The indication in the illustrative embodiment is the model number of the telecommunications terminal. As those who are skilled in the art will appreciate, in some alternative embodiments, the indication might be something else, such as the more explicit “column-centric” or the more generic “IP deskset.”

At task 502, network interface 201 receives a computer file from server 103. In some embodiments, the computer file is in the Hypertext Markup Language format, as is known in the art. The computer file comprises a data-ordering tag and one or more data items to be displayed. In some alternative embodiments, terminal 101 receives the data items through other means (e.g., via another computer file, etc.). The computer file, in some alternative embodiments, might also comprise one or more links that are associated with the data items, wherein the first link is associated with the first data item, the second link with the second data item, and so on.

In some embodiments, the received computer file is based on the display capability indication that was transmitted in the request by terminal 101. For example, the received computer file might comprise a first combination of data-ordering tag and data items, in response to a first display capability indication, while the received computer file might comprise a second combination of data-ordering tag and data items, in response to a second display capability indication.

At task 503, processor 202 maps the one or more received data items into an N-row by M-column array of display cells, wherein N and M are positive integers, as mentioned earlier. In accordance with the illustrative embodiment, processor 202 maps the data items into the array of display cells based on the value of the received data-ordering tag. For example, processor 202 might map the data items into the array in column-first order, unless (i) processor 202 recognizes the received data-ordering tag as a valid tag and (ii) the data-ordering tag indicates that the one or more data items should be mapped into the array of cells in row-first order. As those who are skilled in the art will appreciate, processor 202 might use an alternative set of rules to govern the mapping of data items to display cells.

At task 504, processor 202 maps the one or more received links into array of buttons 302. In accordance with the illustrative embodiment, processor 202 maps the links into array 302 based on the value of the received data-ordering tag. For example, processor 202 might map the links into array 302 in column-first order, unless (i) processor 202 recognizes the received data-ordering tag as a valid tag and (ii) the data-ordering tag indicates that the one or more links should be mapped into array 302 in row-first order. As those who are skilled in the art will appreciate, processor 202 might use an alternative set of rules to govern the mapping of links to buttons.

At task 505, video display unit 205 displays the one or more received data items in the N-row by M-column array of display cells. In some embodiments, N is greater than or equal to two, and M is also greater than or equal to two.

At task 506, processor 202 checks if a button in array 302 is being actuated. If so, task execution proceeds to task 507. If not, task execution bypasses task 507.

At task 507, processor 202 initiates a telecommunications session (e.g., places a telephone call, etc.) to the link mapped to the actuated button. For example, processor 202 might sense that the button next to a data item that reads “Room Service” has been pressed; as a result, processor 202 would then dial the phone number for Room Service that is specified in the corresponding link.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. An apparatus comprising:
a network interface for receiving a computer file that comprises a data-ordering tag, a first data item, a second data item, and a third data item;
a display that is capable of displaying said first data item, said second data item, and said third data item in an N-row by M-column array of cells, wherein N and M are integers, and wherein N≧2, and wherein M≧2; and
a processor for mapping said first data item, said second data item, and said third data item into said array of cells in column-first order unless: (i) said processor recognizes said data-ordering tag as a valid tag and (ii) said data-ordering tag indicates that said first data item, said second data item, and said third data item should be mapped into said array of cells in row-first order.

2. The apparatus of claim 1 further comprising a two-dimensional array of buttons, wherein each of said cells in said array of cells is associated with one or more buttons in said array of buttons.

3. The apparatus of claim 2 wherein said computer file further comprises:
(i) a first link that is associated with said first data item,
(ii) a second link that is associated with said second data item, and
(iii) a third link that is associated with said third data item;
wherein said processor is also for mapping said first link, said second link, and said third link into said array of buttons in column-first order unless: (i) said processor recognizes said data-ordering tag as a valid tag and (ii) said data-ordering tag indicates that said first link, said second link, and said third link should be mapped into said array of buttons in row-first order.

4. The apparatus of claim 3 wherein actuating a button in said array of buttons initiates a telecommunications session to the link mapped to said button.

5. The apparatus of claim 1 wherein said computer file is encoded in the Hypertext Markup Language.

6. An apparatus comprising:
a network interface for receiving a computer file that comprises a data-ordering tag, a first data item, a second data item, and a third data item;
a display that is capable of displaying said first data item, said second data item, and said third data item in an N-row by M-column array of cells, wherein N and M are positive integers;
a two-dimensional array of buttons, wherein each of said cells in said array of cells is associated with one or more buttons in said array of buttons; and
a processor for mapping said first data item, said second data item, and said third data item into said array of cells in column-first order unless: (i) said processor recognizes said data-ordering tag as a valid tag and (ii) said data-ordering tag indicates that said first data item, said second data item, and said third data item should be mapped into said array of cells in row-first order.

7. The apparatus of claim 6 wherein N≧2 and wherein M≧2.

8. The apparatus of claim 6 wherein said computer file further comprises:
(i) a first link that is associated with said first data item,
(ii) a second link that is associated with said second data item, and
(iii) a third link that is associated with said third data item;
wherein said processor is also for mapping said first link, said second link, and said third link into said array of buttons in column-first order unless: (i) said processor recognizes said data-ordering tag as a valid tag and (ii) said data-ordering tag indicates that said first link, said second link, and said third link should be mapped into said array of buttons in row-first order.

9. The apparatus of claim 8 wherein actuating a button in said array of buttons initiates a telecommunications session to the link mapped to said button.

10. The apparatus of claim 6 wherein said computer file is encoded in the Hypertext Markup Language.

11. A method comprising:
receiving a computer file that comprises a data-ordering tag, a first data item, a second data item, and a third data item;
displaying said first data item, said second data item, and said third data item in an N-row by M-column array of cells, wherein N and M are integers, and wherein N≧2, and wherein M≧2; and
mapping said first data item, said second data item, and said third data item into said array of cells in column-first order unless: (i) said data-ordering tag is recognized as a valid tag and (ii) said data-ordering tag indicates that said first data item, said second data item, and said third data item should be mapped into said array of cells in row-first order.

12. The method of claim 11 wherein each of said cells in said array of cells is associated with one or more buttons in a two-dimensional array of buttons.

13. The method of claim 12 further comprising mapping (i) a first link that is associated with said first data item, (ii) a second link that is associated with said second data item, and (iii) a third link that is associated with said third data item, to said array of buttons in column-first order unless: (i) said processor recognizes said data-ordering tag as a valid tag and (ii) said data-ordering tag indicates that said first link, said second link, and said third link should be mapped onto said display in row-first order;
wherein said computer file further comprises said first link, said second link, and said third link.

14. The method of claim 13 further comprising:
sensing a button being actuated in said array of buttons; and
initiating a telecommunications session to the link mapped to said button, based on the sensing of said button being actuated.

15. The method of claim 11 further comprising transmitting, from a telecommunications terminal, a request that comprises a display capability indication of said telecommunications terminal; wherein said computer file is based on said display capability indication.

16. A method comprising:
receiving a computer file that comprises a data-ordering tag, a first data item, a second data item, and a third data item;
displaying said first data item, said second data item, and said third data item in an N-row by M-column array of cells, wherein N and M are positive integers, wherein each of said cells in said array of cells is associated with one or more buttons in a two-dimensional array of buttons; and
mapping said first data item, said second data item, and said third data item into said array of cells in column-first order unless: (i) said data-ordering tag is recognized as a valid tag and (ii) said data-ordering tag indicates that said first data item, said second data item, and said third data item should be mapped into said array of cells in row-first order.

17. The method of claim 16 wherein N≧2 and wherein M≧2.

18. The method of claim 16 further comprising mapping (i) a first link that is associated with said first data item, (ii) a second link that is associated with said second data item, and (iii) a third link that is associated with said third data item, to said array of buttons in column-first order unless: (i) said processor recognizes said data-ordering tag as a valid tag and (ii) said data-ordering tag indicates that said first link, said second link, and said third link should be mapped onto said display in row-first order;
wherein said computer file further comprises said first link, said second link, and said third link.

19. The method of claim 18 further comprising:
sensing a button being actuated in said array of buttons; and
initiating a telecommunications session to the link mapped to said button, based on the sensing of said button being actuated.

20. The method of claim 16 further comprising transmitting, from a telecommunications terminal, a request that comprises a display capability indication of said telecommunications terminal; wherein said computer file is based on said display capability indication.
